(19) United States
(12) Patent Application Publication
(10) Pub. No.: US 2024/0012985 A1
(43) Pub. Date: Jan. 11, 2024

(54) TABLE CONTENT PROCESSING METHOD AND APPARATUS, AND DEVICE AND STORAGE MEDIUM

(71) Applicant: BEIJING ZITIAO NETWORK TECHNOLOGY CO., LTD., Beijing (CN)

(72) Inventors: Wei CHEN, Beijing (CN); Zongyan WEI, Beijing (CN)

(21) Appl. No.: 18/239,719

(22) Filed: Aug. 29, 2023

Related U.S. Application Data
(63) Continuation of application No. PCT/CN2022/078661, filed on Mar. 1, 2022.

(30) Foreign Application Priority Data
Mar. 1, 2021 (CN) 202110227849.2
Mar. 1, 2021 (CN) 202110233247.8

(51) Int. Cl. G06F 40/177; G06F 40/174; G06F 21/62

(52) U.S. Cl. CPC G06F 40/177; G06F 40/174; G06F 21/6227

(57) ABSTRACT

The present disclosure provides a table content processing method and apparatus, and a device and a storage medium. The table content processing method comprises: selecting data row information in a first table; in response to a trigger operation for the data row information, generating a first document or a second table, wherein the first document comprises the second table, and the second table comprises the data row information; and sending the first document or the second table to a target accessing user. By means of the present disclosure, part of content in a table can be directly shared, and two-way data synchronization is supported, such that the usage experience of a user is improved.

### CROSS REFERENCE

The disclosure is a continuation of PCT application Ser. No. PCT/CN2022/078661, titled “TABLE CONTENT PROCESSING METHOD AND APPARATUS, AND DEVICE AND STORAGE MEDIUM”, filed on Mar. 1, 2022, which filed based on the Chinese Patent Application No. 202110227849.2, field on Mar. 1, 2021, titled “TABLE CONTENT PROCESSING METHOD AND APPARATUS, AND DEVICE AND STORAGE MEDIUM”, and Chinese Patent Application No. 202110233247.8, field on Mar. 1, 2021, titled “TABLE CONTENT PROCESSING METHOD AND APPARATUS, AND DEVICE AND STORAGE MEDIUM”, and claims priority to these Chinese Patent Application. All contents of these Chinese Patent Application are incorporated herein by reference.

### TECHNICAL FIELD

The present disclosure relates to the field of computer software technologies, and in particular, to a table content processing method and apparatus, and a device and a storage medium.

### BACKGROUND

With the development of Internet technologies, tables have become a commonly used data management tool. During use, tables are usually shared to other users for viewing and editing. Sometimes, multiple users need to jointly maintain content of a table, and each user is responsible for only partial content of the table and data segregation.

In existing technologies, partial content of a table is often provided to other users by leaving the current table, opening a new table, then copying the corresponding content to the new table, and sending the new table to the users. This process is too cumbersome. If a table is to be entered together, each user is required to create a separate table, edit responsible content, and send the table to someone, and then the content of each table is copied to a main table for summarization. This process is repeated once for each subsequent update of the main table, and therefore, is quite cumbersome.

### SUMMARY

The present disclosure aims to solve the foregoing problems and provide a simple and efficient a table content processing method and apparatus, and a device and a storage medium, which can directly share some content in a table and support two-way synchronization of data or achieve real-time two-way synchronization of some content data in a table. The summary is provided to introduce in brief the concepts which will be described in detail later in the embodiments. The summary of the invention is neither intended to identify key or necessary features of the claimed technical solutions, nor intended to limit the scope of the claimed technical solutions.

In order to solve the above technical problem, embodiments of the present disclosure provide a table content processing method, using the technical solution described below:
selecting data row information in a first table;
generating a first document or second table in response to a trigger operation on the data row information, wherein the first document comprises the second table, and the second table comprises the data row information; and
sending the first document or second table to a target access user.

In order to solve the above technical problem, embodiments of the present disclosure provide a table content processing apparatus, using the technical solution described below, comprising:
an information selection module, configured to select data row information in a first table;
a document generation module, configured to generate a first document or second table in response to a trigger operation on the data row information, wherein the first document comprises the second table, and the second table comprises the data row information;
a document sending module, configured to send the first document or second table to a target access user; and
a reference synchronization module, configured to reference data row information in the second table in a region of the data row information in the first table, highlight an associated region of the data row information in the first table, and in response to an edit operation on the data row information in the second table, display edited data row information in the data row information in the first table.

In order to solve the above technical problem, embodiments of the present disclosure provide a table content processing method, using the technical solution described below:
selecting first data row information in a first table; and
inserting the first data row information into a first document or second table in response to an insertion operation in the first document or second table, to generate second data row information, wherein the first data row information and the second data row information have a reference relationship.

In order to solve the above technical problem, embodiments of the present disclosure provide a table content processing apparatus, using the technical solution described below, comprising:
an information selection module, configured to select first data row information in a first table;
an information insertion module, configured to insert the first data row information into a first document or second table in response to an insertion operation in the first document or second table, to generate second data row information, wherein the first data row information and the second data row information have a reference relationship;
a display module, configured to in response to an edit operation on the first data row information, display edited first data row information in the second data row information, and configured to display the reference relationship with a unique identifier; and
a determination and setting module, configured to determine whether a preset attribute of the first table and a preset attribute of the second table are the same, and in response to the preset attribute of the first table being the same as the preset attribute of the second table, generate the second data row information and determine whether to establish the reference relationship between the second data row information and the first data row information; or in response to the preset attribute of the first table not being the same as the preset attribute of the second table, copy the first data row information to the first document or second table to generate the second data row information, or reject the insertion operation.

In order to solve the above technical problem, embodiments of the present disclosure provide a computer device, using the technical solution described below:
comprising a memory and a processor, the memory storing a computer program, and the processor implementing the method above when executing the computer program.

In order to solve the above technical problem, embodiments of the present disclosure provide a computer-readable storage medium, using the technical solution described below:
the computer-readable storage medium stores a computer program, and the method above is implemented when the computer program is performed by a processor.

According to the technical solutions disclosed in the present disclosure, compared with existing technologies, the present disclosure may directly share some content in a table without creating a new table for copying, pasting, and sharing, thereby simplifying operation processes and improving work efficiency. The present disclosure may also achieve real-time two-way synchronous updates of some content in the table with only one copy, thereby reducing repeated processing in a collaborative process and improving work efficiency.

### BRIEF DESCRIPTION OF THE DRAWINGS

FIG. 1 is a schematic diagram of an exemplary system architecture to which the present disclosure may be applied;

FIG. 2 is a flowchart of an embodiment of a table content processing method according to the present disclosure;

FIG. 3 is a schematic diagram of an embodiment of a table content processing method according to the present disclosure;

FIG. 4 is a schematic diagram of an embodiment of a table content processing method according to the present disclosure;

FIG. 5 is a schematic diagram of an embodiment of a table content processing apparatus according to the present disclosure;

FIG. 6 is a flowchart of another embodiment of a table content processing method according to the present disclosure;

FIG. 7 is a schematic diagram of another embodiment of a table content processing method according to the present disclosure;

FIG. 8 is a schematic diagram of another embodiment of a table content processing apparatus according to the present disclosure; and

FIG. 9 is a schematic structural diagram of an embodiment of a computer device according to the present disclosure.

The foregoing and other features, advantages, and aspects of embodiments of the present disclosure will become more apparent in conjunction with the accompanying drawings and with reference to the following specific embodiments. Throughout the accompanying drawings, the same or similar accompanying markings indicate the same or similar elements. It should be understood that the accompanying drawings are schematic and that the originals and elements are not necessarily drawn to scale.

### DETAILED DESCRIPTION OF PREFERRED EMBODIMENTS

Unless otherwise defined, all technical and scientific terms used herein have the same meaning as commonly understood by those skilled in the art to which this disclosure pertains; the terms used herein in the specification of the application are used only for the purpose of describing specific embodiments, and are not intended to limit the present disclosure; the terms “including” and “having”, and any variations thereof, in the specification of the present disclosure and in the claims and description of the drawings above are intended to cover non-exclusive embodiments. include” and “having” and any variations thereof are intended to cover non-exclusive inclusion. The terms “first”, “second”, etc. in the specification and claims of the present disclosure or in the accompanying drawings described above are used to distinguish between different objects and are not used to describe a particular order.

Reference to “embodiments” herein implies that particular features, structures, or characteristics described in conjunction with embodiments may be included in at least one embodiment of the present disclosure. The presence of the phrase at various points in the specification does not necessarily refer to the same embodiment, nor is it a separate or alternative embodiment that is mutually exclusive of other embodiments. It is understood by those skilled in the art, both explicitly and implicitly, that the embodiments described herein may be combined with other embodiments.

In order to enable those skilled in the art to better understand the presently disclosed embodiments, the technical solutions in the embodiments of the present disclosure will be clearly and completely described below in conjunction with the accompanying drawings.

### System Structure

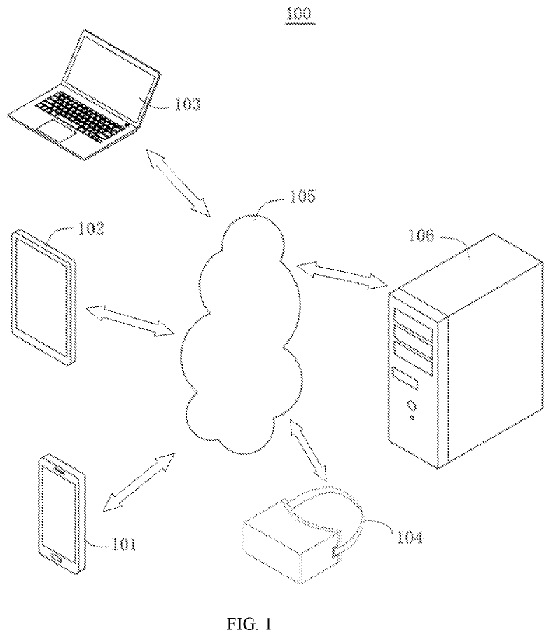

A system structure in one embodiment of the present disclosure is first explained. As shown in FIG. 1, the system structure 100 may include terminal devices 101, 102, 103, and 104, a network 105, and a server 106. The network 105 serves as a medium providing a communication link between the terminal devices 101, 102, 103, and 104 and the server 106.

In this embodiment, an electronic device on which a table content processing method runs (such as the terminal device 101, 102, 103, or 104 shown in FIG. 1) may transmit a variety of information through the network 105. The network 105 may include various types of connections, such as wired or wireless communication links or optical fiber cables. It should be pointed out that the wireless connections may include, but is not limited to, 3G/4G/5G connection, Wi-Fi connection, Bluetooth connection, WiMAX connection, Zigbee connection, UWB connection, and other wireless connections now known or developed in the future.

A user may use the terminal device 101, 102, 103, or 104 to interact with the server 106 through the network 105, so as to receive or send messages and the like. The terminal device 101, 102, 103, or 104 may be installed with various client applications, such as video broadcasting and playback applications, web browser applications, shopping applications, search applications, instant messaging tools, e-mail clients, and social platform software.

The terminal device 101, 102, 103, or 104 may be various electronic devices that have a touch screen and/or support web browsing, including but not limited to a smart phone, a tablet computer, an e-book reader, an MP3 (moving picture experts group audio layer III) player, an MP4 (moving picture experts group audio layer IV) player, a head-mounted display device, a laptop portable computer, a desktop computer, and the like.

The server 106 may be a server providing various services, such as a background server providing support for pages displayed on the terminal device 101, 102, 103, or 104.

It should be understood that numbers of the terminal devices, the network, and the server in FIG. 1 are merely indicative. Any number of terminal devices, networks, and servers may be configured according to implementation requirements.

Here, the terminal device may implement the method in the embodiments of the present disclosure independently, or by cooperating with another electronic terminal device to run applications in an Android system, or by running applications in another operating system, such as an iOS system, a Windows system, or a Harmony OS system.

### Table Content Processing Method

Terminologies of some application scenarios of the present disclosure are first explained,
Data row (record): For example, a row in a table may be referred to as a data row or record. In the table, an order of data rows may be marked by an array to describe a row number of each data row in the table. When one or more data rows are selected, a range in the array is actually selected, and may be described as [start, end], for example.
Index column: For example, an index column may be key information of each record, is used for identifying attribute information of each record, and cannot be deleted. When a user copies and pastes content from one table to another table, index columns of the two tables should be the same. If the index columns are different, the content cannot be pasted.
Field information: For example, the field information may represent titles and attributes of table columns, such as a column representing “most important level” in a table.

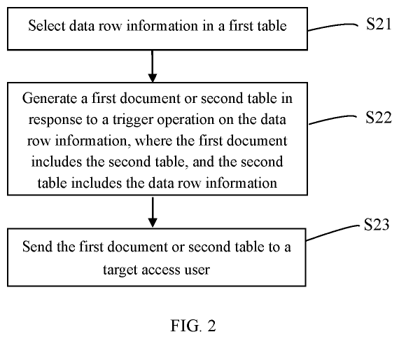

Refer to FIG. 2, which shows a flowchart of an embodiment of a table content processing method according to the present disclosure. The table content processing method includes the following steps:

S21: Select data row information in a first table.

In one or more embodiments, for example, the first table is an original table where the selected data row information is located, and may alternatively be referred to as a main table; and a second table described subsequently is a table after sharing, and may alternatively be referred to as a sub table. The main table and the sub table may be two independent tables or two sub tables in the same table.

Optionally, the data row information in the first table may be selected from an interface of the first table or from another interface that displays the data row information of the first table.

Optionally, the selection operation includes direct regional selection in data rows or selection on identifiers corresponding to data rows, each identifier corresponding to a complete data row. For example, the way of selecting the data row information in the first table may include checking one or more data rows on the main table for selection, that is, selecting a [start, end] range in the array of the main table.

After the data row information is selected, a sharing related tool or menu may be clicked to perform a trigger operation such as a sharing operation, where a display position of the sharing related tool or menu is not limited, namely, the sharing related tool or menu may be located in a menu bar or other tool bars, preferably in a position ahead of the selected one or more data rows, and the sharing related tool automatically pop up when one or more data rows are selected, and display content of the sharing related tool or menu may be, for example, “Convert to a new table” or “Share a new table”, which is not limited.

S22: Generate a first document or second table in response to a trigger operation on the data row information, where the first document includes the second table, and the second table includes the data row information.

In one or more embodiments, for example, the generated first document is the second table, and of course, the first document may alternatively include the second table.

In one or more embodiments, the trigger operation includes at least setting a name of the first document or a name of the second table, or setting a sending object. For example, after the sharing related tool or menu is clicked for a sharing operation, a pop-up window pops up for setting a title or name of a newly generated document or sub table and selecting a target object for sharing.

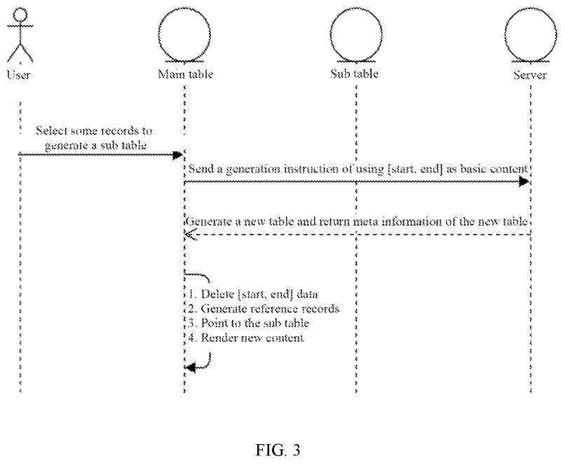

In one or more embodiments, as shown in FIG. 3, content in a selected [start, end] range is used as basic content, a generation instruction of using the content in the selected [start, end] range as basic content is sent to a server to generate a new document or sub table for sharing, and attribute information of the sub table is returned after the new document or sub table is generated, where field information of the new sub table is consistent with that of the main table.

S23: Send the first document or second table to a target access user.

In one or more embodiments, the method further includes referencing data row information in the second table in a region of the data row information in the first table. In one or more embodiments, as shown in FIG. 3, content of [start, end] in the main table is replaced and a special reference data row, namely, a corresponding data row of the second table, is inserted in a corresponding position, to complete referencing of the data row of the second table in the first table.

Optionally, during referencing, displayed rows of the data row information are offset from a start position to achieve consistency between the data row information and content of the second table.

In one or more embodiments, the referencing data row information in the second table in a region of the data row information in the first table includes: highlighting an associated region of the data row information in the first table, for example, highlighting a data row region or highlighting edges of a data row region; or adding an identifier for an associated region of the data row information in the first table. For example, a unique identifier appears within or near the associated region.

In one or more embodiments, a name and/or link of the second table are displayed in response to a trigger operation on the associated region or a trigger operation on the identifier of the associated region. In one or more embodiments, for example, a link to the second table or a name of the second table may appear after the unique identifier is clicked, and the second table may be jumped to after the link to the second table or the name of the second table is clicked.

Optionally, after the first document or second table is generated, an associated region of the referenced corresponding data row information in the second table is highlighted, for example, a data row region is highlighted or edges of a data row region is highlighted; or an identifier is added within or near an associated region of the referenced data row information in the second table.

Optionally, all information of the first table that references the data row information in the second table is displayed in response to a trigger operation on the associated region in the second table or a trigger operation on the identifier of the associated region.

Optionally, after all the information of the first table that references the data row information in the second table is clicked, the corresponding first table may be jumped to.

In one or more embodiments, in response to an edit operation on the data row information in the second table, edited data row information is displayed in the data row information of the first table.

In one or more embodiments, the method further includes: determining permission information of an access user for the first document or second table; and determining display content of the data row information in the first table for the access user based on the permission information, namely, in response to the access user not having permission information, hiding the data row information in the first table and displaying link information of the second table in a region where the data row information in the first table is located; or displaying the data row information in the first table in response to the access user having the permission information.

In one or more embodiments, for example, if the main table has a read permission for the sub table according to a setting of the first table, content of the data row information may be read on the main table, otherwise the content cannot be read; if the main table has an edit permission for the sub table according to a setting of the first table, the content of the data row information may be edited on the main table; when the data row information is edited in the main table, the edited content may be synchronized to the second table, namely, the sub table; and when the sub table is edited, the edited content may be synchronized to the data row information on the main table and may be read or edited.

In one or more embodiments, after the processing of the table content is completed, the table content processing method of the present disclosure further solves conflicts of field information between the shared main table and sub table. In one or more embodiments, the field information includes, for example, at least column headings and/or column attributes.

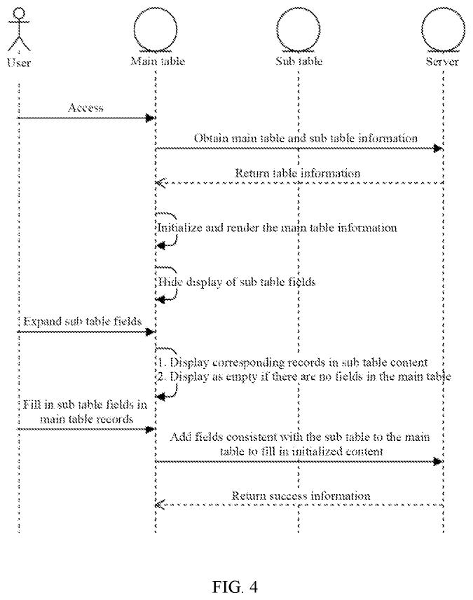

In one or more embodiments, conflicts may occur between the main table and the sub table due to inconsistent field information. As shown in FIG. 4, the table content processing method of the present disclosure further includes:
when the user accesses the main table, obtaining field information of the main table and all sub tables, and returning the obtained table information;
for the main table, displaying all information as initialized data; and
for each sub table, checking whether the field information of the sub table is consistent with that of the main table; if consistent, following a logic of the main table for display; if inconsistent, for example, if there are partial fields not exist in the main table, hiding the field information in the sub table; and displaying the inconsistent field information as empty in both the main table and the sub table.

If field information that exists in sub table is added to one of the main table and the sub table, such as the main table, the field information is inserted into the main table and corresponding initialized content is filled in. Because the field information is added to the main table, each data row will have the field information which is defaulted as empty content, and the content of the main table and the sub table will be synchronized after successful filling.

In one or more embodiments, after table sharing, an owner of the main table and a sharing target object may receive a notification on instant messaging software, so that the processing of table documents is more timely and efficient.

It should be understood that, although all steps in the accompanying flowcharts are displayed in order indicated by arrows, these steps are not necessarily executed in the order indicated by the arrows. Unless otherwise explicitly specified herein, the execution of these steps is not strictly limited, and these steps may be executed in other order. In addition, at least some steps in the accompanying flowcharts may include a plurality of sub-steps or a plurality of stages. These sub-steps or stages are not necessarily executed or completed at the same time, but may be executed at different time. These sub-steps or stages are also not necessarily executed successively, but may be executed in turn or alternately with at least some other steps or sub-steps of other steps or other stages.

A person of ordinary skill in the art may understand that all or some of the processes of the methods in the foregoing embodiments may be implemented by a computer program instructing relevant hardware. The program may be stored in a computer-readable storage medium. When the program is performed, the processes of the foregoing method embodiments are performed. The storage medium may be a non-volatile storage medium such as a magnetic disk, an optical disk, or a read-only memory (ROM), a random access memory (RAM), or the like.

### Table Content Processing Apparatus

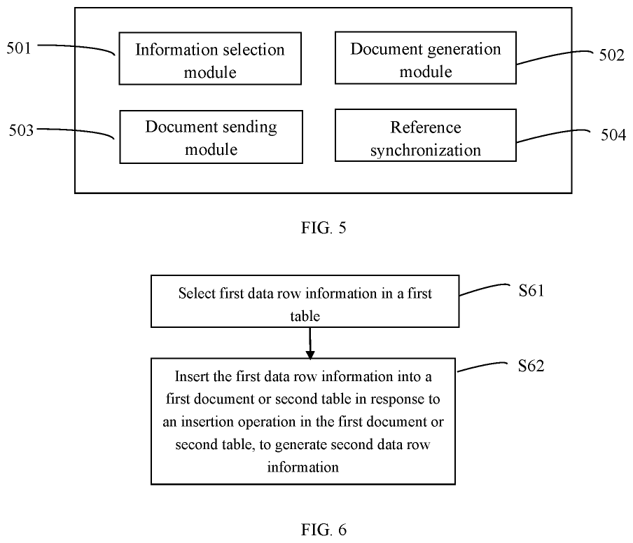

As shown in FIG. 5, in order to implement the technical solutions in the embodiments of the present disclosure, the present disclosure provides a table content processing apparatus. The apparatus may be specifically applied to various electronic terminal devices. The terms, phrases, and the like in the table content processing apparatus of the present disclosure, which are consistent with those in the foregoing table content processing method, will not be repeated.

The table content processing apparatus described in this embodiment includes: an information selection module 501, a document generation module 502, a document sending module 503, and a reference synchronization module 504.

The information selection module 501 is configured to select data row information in a first table.

In one or more embodiments, for example, the first table is an original table where the selected data row information is located, and may alternatively be referred to as a main table; and a second table is a table after sharing, and may alternatively be referred to as a sub table.

In one or more embodiments, the way for the information selection module 501 to determine the data row information in the first table may include checking one or more data rows on the main table for selection, that is, selecting a [start, end] range in an array of the main table.

After selecting the data row information, the information selection module 501 is configured to click a sharing related tool or menu for a trigger operation such as a sharing operation, where a display position of the sharing related tool or menu is not limited, namely, the sharing related tool or menu may be located in a menu bar or other tool bars, preferably in a position ahead of the selected one or more data rows, the selected one or more data rows automatically pop up, and display content of the sharing related tool or menu may be, for example, “Convert to a new table” or “Share a new table”, which is not limited.

The document generation module 502 is configured to generate a first document or second table in response to a trigger operation on the data row information, where the first document includes the second table, and the second table includes the data row information.

In one or more embodiments, for example, the generated first document is the second table, and of course, the first document may alternatively include the second table.

In one or more embodiments, the apparatus further includes a sharing setting module, configured to set a name of the first document or a name of the second table, or set a sending object. For example, the trigger operation includes at least setting a name of the first document or a name of the second table, or setting a sending object. For example, after the sharing related tool or menu is clicked for a sharing operation, a pop-up window pops up for setting a title or name of a table and selecting a target object for sharing.

In one or more embodiments, as shown in FIG. 3, the sharing setting module is configured to use content in a selected [start, end] range as basic content, send a generation instruction of using the content in the selected [start, end] range as basic content to a server to generate a new document or sub table for sharing, and return attribute information of the sub table after the new document or sub table is generated, where field information of the new sub table is consistent with that of the main table.

The document sending module 503 is configured to send the first document or second table to a target access user.

In one or more embodiments, the apparatus further includes a reference synchronization module 504, configured to reference data row information in the second table in a region of the data row information in the first table. In one or more embodiments, as shown in FIG. 3, the reference synchronization module 504 is configured to delete content of [start, end] in the main table from the main table, insert a new special reference data row, namely, a corresponding data row of the second table, in a start position, to complete reference, and offset displayed rows of the data row information from the start position to achieve consistency between the data row information and content of the second table.

The reference synchronization module 504 is further configured to in response to an edit operation on the data row information in the second table, display edited data row information in the data row information of the first table.

In one or more embodiments, the apparatus further includes a permission control module, configured to determine permission information of an access user for the first document or second table; and determine display content of the data row information in the first table for the access user based on the permission information.

In one or more embodiments, the permission control module is further configured to hide the data row information in the first table and display link information of the second table in a region where the data row information is located in response to not having permission information; or in response to having the permission information display the data row information in the first table.

In one or more embodiments, the permission control module may further control the following: if the main table has a read permission for the sub table according to a setting of the first table, content of the data row information may be read on the main table, otherwise the content cannot be read; if the main table has an edit permission for the sub table according to a setting of the first table, the content of the data row information may be edited on the main table; when the data row information is edited in the main table, the edited content may be synchronized to the second table, namely, the sub table; and when the sub table is edited, the edited content may be synchronized to the data row information on the main table and may be read or edited.

In one or more embodiments, the apparatus further includes a display module, configured to highlight an associated region of the data row information in the first table, for example, a unique identifier appears on the associated region; the display module is further configured to display a name and/or link of the second table in response to a trigger operation on the associated region. In one or more embodiments, for example, a link to the second table or a name of the second table may appear after the unique identifier is clicked, and the second table may be jumped to after the link to the second table or the name of the second table is clicked.

In one or more embodiments, after the processing of the table content is completed, the table content processing apparatus of the present disclosure further solves conflicts of field information between the shared main table and sub table. In one or more embodiments, the field information includes, for example, at least column headings and/or column attributes.

In one or more embodiments, conflicts may occur between the main table and the sub table due to inconsistent field information, and the table content processing apparatus of the present disclosure further includes:
a field information obtaining module, configured to obtain field information of the main table and all sub tables, and return the obtained table information, where for the main table, all information is displayed as initialized data;
a field information detection module, configured to detect whether the field information of each sub table is consistent with that of the main table;
a field information display module, configured to display the detection result of the field information detection module, namely, if consistent, follow a logic of the main table for display; if inconsistent, for example, if there are partial fields not exist in the main table, hide the field information in the sub table; and display the inconsistent field information as empty in both the main table and the sub table; and
a field information addition module, configured to, if field information that exists in sub table is added to one of the main table and the sub table, such as the main table, insert the field information into the main table and fill in corresponding initialized content. Because the field information is added to the main table, each data row will have the field information which is defaulted as empty content, and the content of the main table and the sub table will be synchronized after successful filling.

In one or more embodiments, the apparatus further includes a notification module, configured to enable an owner of the main table and a sharing target object to receive a notification on instant messaging software after table sharing, so that the processing of table documents is more timely and efficient.

### Another Embodiment of the Table Content Processing Method

Terminologies of some application scenarios of the present disclosure are first explained,
Record: For example, a row in a table may be referred to as a record. In the table, an order of records may be marked by an array to describe a row number of each record in the table. When one or more records are selected, a range in the array is actually selected, and may be described as [start, end], for example.
Index column: For example, an index column may be key information of each record, is used for identifying attribute information of each record, and cannot be deleted. When a user copies and pastes content from one table to another table, index columns of the two tables should be the same. If the index columns are different, the content cannot be pasted.
Field information: For example, the field information may represent titles and attributes of table columns, such as a column representing “most important level” in a table.

Refer to FIG. 6, which shows a flowchart of an embodiment of a table content processing method according to the present disclosure. The table content processing method includes the following steps:

S61: Select first data row information in a first table.

In one or more embodiments, for example, the first table is an original table where the first data row information is located, and may alternatively be referred to as a sub table; and a second table described in subsequent steps is a table with content for reference, and may alternatively be referred to as a main table.

In one or more embodiments, the way of selecting the first data row information in the first table may include, for example, checking one or more records on the sub table for selection, that is, selecting a [start, end] range in an array of the sub table, writing a version of the table at this time, and recording the version.

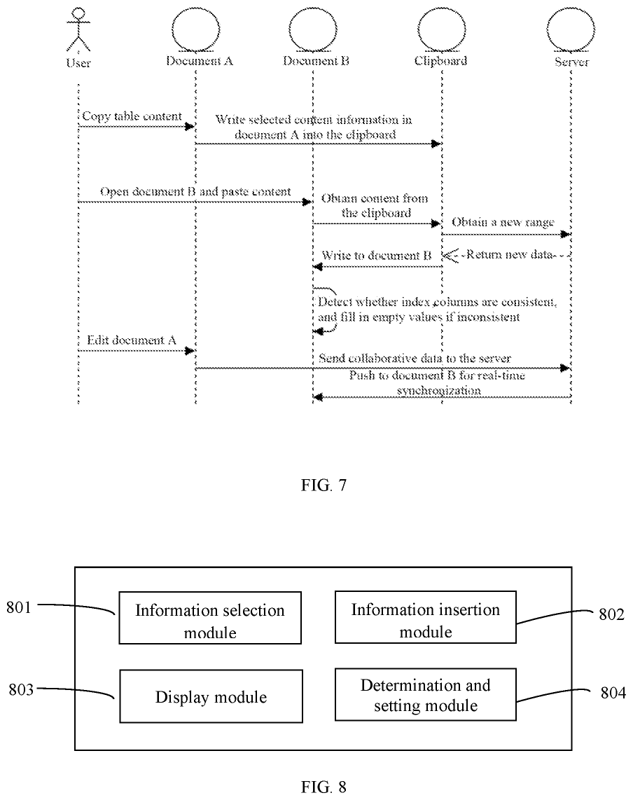

As shown in FIG. 7, document A is a sub table and document B is a main table. After the foregoing reference content is selected, the selected first data row information, namely, reference content, is copied and the selected reference content is written into a clipboard.

In one or more embodiments, a reference operation may be performed by clicking a reference trigger tool or menu, where a display position of the reference trigger tool or menu is not limited, namely, the reference trigger tool or menu may be located in a menu bar or other tool bars, preferably in a position ahead of the selected one or more records, and the reference trigger tool or menu automatically pop up when one or more records are selected, and display content of the reference trigger tool or menu may be, for example, “Copy a real-time reference” or “Create a real-time reference”, which is not limited.

S62: Insert the first data row information into a first document or second table in response to an insertion operation in the first document or second table, to generate second data row information, where the first data row information and the second data row information have a reference relationship.

In one or more embodiments, as shown in FIG. 7, the first document or second table is opened, the first data row information, namely, reference content, is obtained from the clipboard, and inserted into the first document or second table in response to the insertion operation to generate the second data row information. In one or more embodiments, the first document may include the second table, and of course, may be an independent different document.

In one or more embodiments, whether a preset attribute of the first table and a preset attribute of the second table are the same is also determined in response to the insertion operation in the first document or second table, and if the preset attribute of the first table being the same as the preset attribute of the second table, the second data row information is generated and whether to establish the reference relationship between the second data row information and the first data row information is determined; or if in response to the preset attribute of the first table not being the same as the preset attribute of the second table, the first data row information is copied to the first document or second table to generate the second data row information, or the insertion operation is rejected.

In one or more embodiments, the preset attribute may be, for example, an index column mentioned above, or may include a data type of the index column; and the way of establishing the reference relationship between the second data row information and the first data row information is, for example, real-time reference.

In one or more embodiments, for a database table with index columns having set fixed data types (namely, only a fixed type of data can be input to each column, for example, only personnel can be input to column a and only time and date can be input to column b), whether the preset attribute of the first table and the preset attribute of the second table are the same is determined in response to the insertion operation in the first document or second table, and the second data row information is generated and whether to paste as “real-time reference” is prompted if the two tables have the same index column(s), or “The index columns are different and paste is not supported” is prompted if the index columns of the two tables are different.

In one or more embodiments, for an ordinary spreadsheet, its index columns having no fixed data types when created (different types of data may be input to each column at the same time). In response to the insertion operation in the first document or second table, whether the preset attribute of the first table and the preset attribute of the second table are the same is determined, if the same, the second data row information is generated, and whether to establish the reference relationship between the second data row information and the first data row information is determined; or if different, the first data row information is copied to the first document or second table to generate the second data row information.

In one or more embodiments, as long as the index columns are the same, the copy and paste may succeed, even if the columns of the two tables are not exactly the same.

In one or more embodiments, the method further includes: generating a reference trigger region in response to the insertion operation in the first document or second table, where the foregoing reference trigger tool or menu is configured in the reference trigger region, and the way of generating the second data row information may be determined through a trigger operation on the reference trigger tool or menu in the reference trigger region. In one or more embodiments, in response to a first trigger operation on the reference trigger region, the second data row information is generated and the reference relationship between the second data row information and the first data row information is established. Specifically, when the first data row information is inserted into the first document or second table to generate the second data row information, for example, when one or more records are selected, the reference trigger tool or menu automatically pops up, where display content of the reference trigger tool or menu may be, for example, “Copy a real-time reference” or “Create a real-time reference”, which is not limited. In one or more embodiments, in response to a second trigger operation on the reference trigger region, only the first data row information is copied to the first document or second table, to generate the second data row information. Specifically, when the first data row information is inserted into the first document or second table to generate the second data row information, for example, when the insertion operation is performed in the second table, the foregoing real-time reference way is not configured or canceled, but a text of the first data row information is directly inserted to be copied to the first document or second table to generate the second data row information. In this case, this portion of the first data row information is updated on the sub table, and will not be synchronously updated on the main table; and the second data row information is updated on the main table, and will also not be synchronously updated on the sub table.

In one or more embodiments, if the range of [start, end] in the first table has been modified when the first data row information is inserted into the second table, the server computes a new [start, end] through the version and a collaborative algorithm to describe the new table range and update the range to the second table.

In one or more embodiments, the reference relationship between the second data row information in the second table and the first data row information in the first table is established by a real-time reference way, and the reference relationship is displayed with a specific identifier on the first data row information and the second data row information, for example, a first reference identifier is displayed in an associated region of the first data row information in the first table, and a second reference identifier is displayed in an associated region of the second data row information in the second table, where display positions of the associated regions of the first reference identifier and the second reference identifier are not limited, and may be located in a menu bar or other tool bars or within a distance range of the first data row information or the second data row information.

In one or more embodiments, referenced information of the first data row information is displayed in response to a trigger operation on the first reference identifier of the first data row information, and content update information of the second data row information and/or data source information such as documents/tables are displayed in response to a trigger operation on the second reference identifier of the second data row information. For example, information about reference of the first data row information by other documents or tables may appear after the first reference identifier of the first data row information is clicked, a link to the first table or a name of the first table may appear after the second reference identifier of the second data row information is clicked, and the first table may be jumped to after the link to the first table or the name of the first table is clicked. In one or more embodiments, the second reference identifier further displays latest update time and update person at the referenced associated region, whereby the update time and update person may be known even if the referenced sub table is not opened; or the second reference identifier displays a name of a sub table of a source document in the referenced position, the first reference identifier displays in the position of the source document which tables are referenced, and the tables may be jumped to each other for viewing, so that the tables are linked.

In one or more embodiments, in response to an edit operation on the first data row information, edited first data row information is displayed in the second data row information, and changes in the first data row information and the second data row information in the first table and the second table are detected and synchronized according to the reference relationship.

As shown in FIG. 7, whether ranges of the first data row information and the second data row information in the first table and the second table changed is detected, if the first data row information and the second data row information in the first table and the second table are edited, collaborative data are sent to the server after the first data row information or the second data row information changed, and the data are synchronized to the main table or sub table.

In one or more embodiments, after the processing of the table content is completed, the table content processing method of the present disclosure further solves conflicts of field information between the referenced main table and sub table. In one or more embodiments, the field information includes, for example, at least column headings and/or column attributes.

In one or more embodiments, conflicts may occur between the main table and the sub table due to inconsistent field information, and the table content processing method of the present disclosure further includes:
when the user accesses the main table, obtaining field information of the main table and all sub tables, and returning the obtained table information;
for the main table, displaying all information as initialized data; and
for each sub table, checking whether the field information of the sub table is consistent with that of the main table; if consistent, following a logic of the main table for display; if inconsistent, for example, if there are partial fields not exist in the main table, hiding the field information in the sub table; and displaying the inconsistent field information as empty in both the main table and the sub table.

If field information that exists in sub table is added to one of the main table and the sub table, such as the main table, the field information is inserted into the main table and corresponding initialized content is filled in. Because the field information is added to the main table, each record will have the field information which is defaulted as empty content, and the content of the main table and the sub table will be synchronized after successful filling.

It should be understood that, although all steps in the accompanying flowcharts are displayed in order indicated by arrows, these steps are not necessarily executed in the order indicated by the arrows. Unless otherwise explicitly specified herein, the execution of these steps is not strictly limited, and these steps may be executed in other order. In addition, at least some steps in the accompanying flowcharts may include a plurality of sub-steps or a plurality of stages. These sub-steps or stages are not necessarily executed or completed at the same time, but may be executed at different time. These sub-steps or stages are also not necessarily executed successively, but may be executed in turn or alternately with at least some other steps or sub-steps of other steps or other stages.

A person of ordinary skill in the art may understand that all or some of the processes of the methods in the foregoing embodiments may be implemented by a computer program instructing relevant hardware. The program may be stored in a computer-readable storage medium. When the program is performed, the processes of the foregoing method embodiments are performed. The storage medium may be a non-volatile storage medium such as a magnetic disk, an optical disk, or a read-only memory (ROM), a random access memory (RAM), or the like.

### Another Embodiment of the Table Content Processing Apparatus

As shown in FIG. 8, in order to implement the technical solutions in the embodiments of the present disclosure, the present disclosure provides a table content processing apparatus. The apparatus may be specifically applied to various electronic terminal devices. The terms, phrases, and the like in the table content processing apparatus of the present disclosure, which are consistent with those in the foregoing table content processing method, will not be repeated.

The table content processing apparatus described in this embodiment includes: an information selection module 801, an information insertion module 802, a display module 803, and a determination and setting module 804.

The information selection module 801 is configured to select first data row information in a first table.

In one or more embodiments, for example, the first table is an original table where the first data row information is located, and may alternatively be referred to as a sub table; and a second table described in subsequent steps is a table with content for reference, and may alternatively be referred to as a main table.

In one or more embodiments, the way for the information selection module 801 to determine the first data row information in the first table may include, for example, checking one or more records on the sub table for selection, that is, selecting a [start, end] range in an array of the sub table, writing a version of the table at this time, and recording the version.

As shown in FIG. 7, document A is a sub table and document B is a main table. After selecting the foregoing first data row information, the information selection module 801 copies the selected first data row information, namely, reference content, and writes the selected reference content into a clipboard.

In one or more embodiments, the information selection module 801 may further perform a reference operation by clicking a reference trigger tool or menu, where a display position of the reference trigger tool or menu is not limited, namely, the reference trigger tool or menu may be located in a menu bar or other tool bars, preferably in a position ahead of the selected one or more records, the selected one or more records automatically pop up, and display content of the reference trigger tool or menu may be, for example, “Copy a real-time reference” or “Create a real-time reference”, which is not limited.

The information insertion module 802 is configured to insert the first data row information into a first document or second table in response to an insertion operation in the first document or second table, to generate second data row information, where the first data row information and the second data row information have a reference relationship.

In one or more embodiments, as shown in FIG. 7, the information insertion module 802 is configured to open the first document or second table, obtain the first data row information, namely, reference content, from the clipboard, and write the reference content into the first document or second table to generate the second data row information. In one or more embodiments, the first document may include the second table, and of course, may be an independent different document.

As shown in FIG. 7, the information insertion module 802 is further configured to detect whether ranges of the reference content, namely, the first data row information and the second data row information, in the first table and the second table change, send changed collaborative data to the information insertion module 802 if the reference content in the first table and the second table is edited, and synchronize the data to the main table.

In one or more embodiments, the information insertion module 802 is further configured to generate a reference trigger region in response to the insertion operation in the first document or second table, where the foregoing reference trigger tool or menu is configured in the reference trigger region, and the way of generating the second data row information may be determined through a trigger operation on the reference trigger tool or menu in the reference trigger region. In one or more embodiments, in response to a first trigger operation on the reference trigger region, the second data row information is generated and the reference relationship between the second data row information and the first data row information is established. Specifically, when the first data row information is inserted into the first document or second table to generate the second data row information, for example, when one or more records are selected, the reference trigger tool or menu automatically pops up, where display content of the reference trigger tool or menu may be, for example, “Copy a real-time reference” or “Create a real-time reference”, which is not limited. In one or more embodiments, the information insertion module 802 is further configured to in response to a second trigger operation on the reference trigger region, copy only the first data row information to the first document or second table to generate the second data row information. Specifically, when inserting the first data row information into the first document or second table to generate the second data row information, for example, when performing the insertion operation in the second table, the information insertion module 802 does not configure the real-time reference way or cancels the real-time reference way, but directly inserts a text of the first data row information to be copied to the first document or second table to generate the second data row information. In this case, this portion of the first data row information is updated on the sub table, and will not be synchronously updated on the main table; and the second data row information is updated on the main table, and will also not be synchronously updated on the sub table.

In one or more embodiments, if the range of [start, end] in the first table has been modified when the first data row information is inserted into the second table, the information insertion module 802 computes a new [start, end] through the version and a collaborative algorithm to describe the new table range and update the range to the second table.

In one or more embodiments, the information insertion module 802 is further configured to establish the reference relationship between the second data row information in the second table and the first data row information in the first table by a real-time reference way.

In one or more embodiments, the apparatus further includes a display module 803, configured to display the reference relationship with a specific identifier on the first data row information and the second data row information, for example, display a first reference identifier in an associated region of the first data row information in the first table, and display a second reference identifier in an associated region of the second data row information in the second table, where display positions of the associated regions of the first reference identifier and the second reference identifier are not limited, and may be located in a menu bar or other tool bars or within a distance range of the first data row information or the second data row information.

The display module 803 is further configured to display referenced information of the first data row information in response to a trigger operation on the first reference identifier of the first data row information, and display content update information of the second data row information and/or data source information such as documents/tables in response to a trigger operation on the second reference identifier of the second data row information. For example, information about reference of the first data row information by other documents or tables may appear after the first reference identifier of the first data row information is clicked, a link to the first table or a name of the first table may appear after the second reference identifier of the second data row information is clicked, and the first table may be jumped to after the link to the first table or the name of the first table is clicked. In one or more embodiments, the second reference identifier further displays latest update time and update person at the referenced associated region, whereby the update time and update person may be known even if the referenced sub table is not opened; or the second reference identifier displays a name of a sub table of a source document in the referenced position, the first reference identifier displays in the position of the source document which tables are referenced, and the tables may be jumped to each other for viewing, so that the tables are linked.

In one or more embodiments, the display module 803 is further configured to in response to an edit operation on the first data row information, display edited first data row information in the second data row information, and detect and synchronize changes in the first data row information and the second data row information in the first table and the second table according to the reference relationship; and
the determination and setting module 804 is configured to determine whether a preset attribute of the first table and a preset attribute of the second table are the same in response to the insertion operation in the first document or second table, and in response to the preset attribute of the first table being the same as the preset attribute of the second table, generate the second data row information and determine whether to establish the reference relationship between the second data row information and the first data row information; or in response to the preset attribute of the first table not being the same as the preset attribute of the second table, copy the first data row information to the first document or second table to generate the second data row information, or reject the insertion operation; and determine whether to establish the reference relationship between the second data row information and the first data row information when the first data row information is inserted into the first document or second table to generate the second data row information.

In one or more embodiments, the preset attribute may be, for example, an index column mentioned above, or may include a data type of the index column; and the way of establishing the reference relationship between the second data row information and the first data row information is, for example, real-time reference.

In one or more embodiments, for a database table with index columns having set fixed data types (namely, only a fixed type of data can be input to each column, for example, only personnel can be input to column a and only time and date can be input to column b), whether the preset attribute of the first table and the preset attribute of the second table are the same is determined in response to the insertion operation in the first document or second table, and the second data row information is generated and whether to paste as “real-time reference” is prompted if the two tables have the same index column(s), or “The index columns are different and paste is not supported” is prompted if the index columns of the two tables are different.

In one or more embodiments, for an ordinary spreadsheet with index columns having no fixed data types during creation (different types of data may be input to each column at the same time), in response to the insertion operation in the first document or second table, if the preset attribute of the first table and the preset attribute of the second table are determined to be the same, the second data row information is generated, and whether to establish the reference relationship between the second data row information and the first data row information is determined; or if different, the first data row information is copied to the first document or second table to generate the second data row information.

In one or more embodiments, the determination and setting module 804 only needs to ensure that the index columns are the same to succeed in copy and paste even if the columns of the two tables are not exactly the same.

In one or more embodiments, after the processing of the table content is completed, the table content processing method of the present disclosure further solves conflicts of field information between the referenced main table and sub table. In one or more embodiments, the field information includes, for example, at least a column heading and/or a column attribute.

In one or more embodiments, conflicts may occur between the main table and the sub table due to inconsistent field information, and the table content processing apparatus of the present disclosure further includes:
a field information obtaining module, configured to obtain field information of the main table and all sub tables, and return the obtained table information, where for the main table, all information is displayed as initialized data;
a field information detection module, configured to detect whether the field information of each sub table is consistent with that of the main table;
a field information display module, configured to display the detection result of the field information detection module, namely, if consistent, follow a logic of the main table for display; if inconsistent, for example, if there are partial fields not exist in the main table, hide the field information in the sub table; and display the inconsistent field information as empty in both the main table and the sub table; and
a field information addition module, configured to, if field information that exists in sub table is added to one of the main table and the sub table, such as the main table, insert the field information into the main table and fill in corresponding initialized content. Because the field information is added to the main table, each record will have the field information which is defaulted as empty content, and the content of the main table and the sub table will be synchronized after successful filling.

It should be understood that each block in the block diagrams of the accompanying drawings may represent a module, and a portion of the module includes one or more executable instructions for implementing specified logic functions, but these modules are not necessarily performed in preset order. The modules and functional units in the apparatus embodiment of the present disclosure may be integrated into a single processing module, or each unit may physically exist alone, or two or more modules or functional units may be integrated into one module. The integrated module may be implemented in a form of hardware or a software functional module. When the integrated module is implemented in the form of a software functional module and sold or used as an independent product, the integrated module may alternatively be stored in a computer-readable storage medium. The storage medium mentioned above may be a read-only memory, a magnetic disk, or an optical disk, or the like.

### Table Content Processing Device

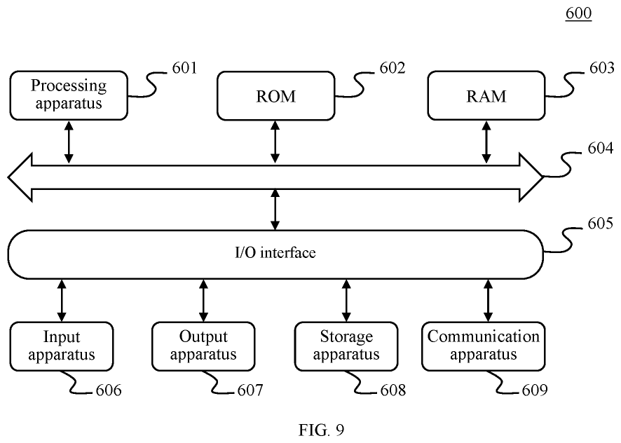

To solve the foregoing technical problems, an embodiment of the present disclosure further provides an electronic device. Hereinafter, refer to FIG. 9, which shows a schematic structural diagram of an electronic device (for example, the terminal device or server in FIG. 1) 600 adapted to implement the embodiments of the present disclosure. The terminal device in the embodiments of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle terminal (for example, a vehicle navigation terminal), and fixed terminals such as a digital TV and a desktop computer. The electronic device shown in FIG. 9 is merely an example, and should not limit the functions and scope of usage of the embodiments of the present disclosure.

As shown in FIG. 9, the electronic device 600 may include a processing apparatus (e.g., a central processor, a graphics processor, etc.) 601 that may perform various appropriate actions and processes based on a program stored in a read-only memory (ROM) 602 or a program loaded from a storage apparatus 608 into a random access memory (RAM) 603. Also stored in the RANI 603 are various programs and data necessary for the operation of the electronic device 600. The processing apparatus 601, the ROM 602, and the RANI 603 are connected to each other via a bus 604. An input/output (I/O) interface 605 is also connected to the bus 604.

Typically, the following devices may be connected to the I/O interface 605: an input apparatus 606 including, for example, a touch screen, a touch pad, a keyboard, a mouse, a camera, a microphone, an accelerometer, a gyroscope, and the like; an output apparatus 607 including, for example, a liquid crystal display (LCD), a loudspeaker, a vibrator, and the like; a storage apparatus 608 including, for example, a magnetic tape, a hard disk, and the like; and a communication apparatus 609. The communication apparatus 609 may allow the electronic device 600 to communicate wirelessly or wiredly with other devices to exchange data. While FIG. 6 illustrates electronic device 600 with various devices, it should be understood that it is not required to implement or have all of the illustrated devices. More or fewer devices may alternatively be implemented or possessed.

In particular, according to embodiments of the present disclosure, the process described above with reference to the flowchart may be implemented as a computer software program. For example, embodiments of the present disclosure include a computer program product comprising a computer program carried on a non-transitory computer-readable medium, the computer program comprising program code for performing the method shown in the flowchart. In such embodiments, the computer program may be downloaded and installed from a network via a communication apparatus 609, or from a storage apparatus 608, or from a ROM 602. When this computer program is executed by the processing apparatus 601, the above-described functions defined in the method of an embodiment of the present disclosure are performed.

It is noted that the computer-readable medium described above in the present disclosure may be a computer-readable signaling medium or a computer-readable storage medium or any combination thereof. The computer-readable storage medium may, for example, be - but is not limited to - a system, device, or apparatus or device of electricity, magnetism, light, electromagnetism, infrared, or semiconductors, or any combination of the above. More specific examples of computer-readable storage media may include, but are not limited to: an electrical connection having one or more wires, a portable computer disk, a hard disk, a random access memory (RAM), a read-only memory (ROM), an erasable programmable read-only memory (EPROM or flash memory), a fiber optic, a compact disk read-only memory (CD-ROM) for portability, an optical storage device, magnetic memory device, or any suitable combination of the foregoing. In the context of the present disclosure, a computer-readable storage medium may be any tangible medium containing or storing a program that may be used by or in combination with an instruction execution system, apparatus, or device. And in the context of the present disclosure, a computer-readable signal medium may include a data signal propagated in a baseband or as part of a carrier that carries computer-readable program code. Such propagated data signals may take a variety of forms, including, but not limited to, electromagnetic signals, optical signals, or any suitable combination of the foregoing. The computer-readable signal medium may also be any computer-readable medium other than a computer-readable storage medium that sends, propagates, or transmits a program for use by, or in combination with, an instruction-executing system, apparatus, or device. The program code contained on the computer-readable medium may be transmitted using any suitable medium, including, but not limited to: wire, fiber optic cable, RF (radio frequency), etc., or any suitable combination of the foregoing.

In some implementations, the client, server may communicate utilizing any currently known or future developed network protocol such as HTTP (Hypertext Transfer Protocol) and may be interconnected with digital data communications (e.g., communication networks) of any form or medium. Examples of communication networks include local area networks (“LANs”), wide area networks (“WANs”), inter-networks (e.g., the Internet), and end-to-end networks (e.g., adhoc end-to-end networks), as well as any currently known or future developed networks.

Said computer-readable medium may be contained in said electronic device; or it may stand alone and not be assembled into said electronic device.

Said computer-readable medium carries one or more programs which, when said one or more programs are executed by said electronic device, cause said electronic device to perform any one of the method above.

Computer program code for performing the operations of the present disclosure may be written in one or more programming languages, or combinations thereof, including, but not limited to, object-oriented programming languages—such as Java, Smalltalk, C++—and conventional procedural programming languages—such as the “C” language or the like. “C” or similar programming languages. The program code may be executed entirely on the user's computer, partially on the user's computer, as a stand-alone software package, partially on the user's computer and partially on a remote computer, or entirely on a remote computer or server. In the case involving a remote computer, the remote computer may be connected to the user computer via any kind of network—including a local area network (LAN) or a wide area network (WAN)—or, alternatively, it may be connected to an external computer (e.g., by utilizing an Internet service provider to connect via the Internet).

The flowcharts and block diagrams in the accompanying drawings illustrate the architecture, functionality, and operation of systems, methods, and computer program products that may be implemented in accordance with various embodiments of the present disclosure. At this point, each box in the flowcharts or block diagrams may represent a module, program segment, or portion of code that contains one or more executable instructions for implementing a specified logical function. It should also be noted that in some implementations as replacements, the functions labeled in the boxes may also occur in a different order than those labeled in the accompanying drawings. For example, two consecutively represented boxes may actually be executed substantially in parallel, and they may sometimes be executed in reverse order, depending on the function involved. It should also be noted that each of the boxes in the block diagrams and/or flowcharts, and combinations of the boxes in the block diagrams and/or flowcharts, may be implemented with a specialized hardware-based system that performs the specified function or operation, or may be implemented with a combination of specialized hardware and computer instructions.

The units described in the embodiments of the present disclosure may be implemented by way of software or by way of hardware. Wherein, the name of a unit does not constitute a limitation of the unit itself in a particular case.

In the context of the present disclosure, a machine-readable medium may be a tangible medium that may contain or store a program for use by or in conjunction with an instruction execution system, device, or apparatus. The machine-readable medium may be a machine-readable signal medium or a machine-readable storage medium. The machine-readable medium may include, but is not limited to, an electronic, magnetic, optical, electromagnetic, infrared, or semiconductor system, device, or apparatus, or any suitable combination of the foregoing. More specific examples of machine-readable storage media would include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination of the foregoing. any suitable combination of the above.

According to one or more embodiments of the present disclosure, provided a table content processing method, comprising:
selecting data row information in a first table;
generating a first document or second table in response to a trigger operation on the data row information, wherein the first document comprises the second table, and the second table comprises the data row information; and
sending the first document or second table to a target access user.

According to one or more embodiments of the present disclosure, provided a table content processing method, the method further comprises:

referencing data row information in the second table in a region of the data row information in the first table.

According to one or more embodiments of the present disclosure, provided a table content processing method, the method further comprises:
in response to an edit operation on the data row information in the second table, displaying edited data row information in the data row information of the first table.

According to one or more embodiments of the present disclosure, provided a table content processing method, the referencing data row information in the second table in a region of the data row information in the first table comprises:
highlighting an associated region of the data row information in the first table.

According to one or more embodiments of the present disclosure, provided a table content processing method, the method further comprises:
displaying a name and/or link of the second table in response to a trigger operation on the associated region.

According to one or more embodiments of the present disclosure, provided a table content processing method, the trigger operation comprises setting a name of the first document or a name of the second table, or setting a sending object.

According to one or more embodiments of the present disclosure, provided a table content processing method, further comprising:
determining permission information of an access user for the first document or second table; and
determining display content of the data row information in the first table for the access user based on the permission information.

According to one or more embodiments of the present disclosure, provided a table content processing method, the determining display content of the data row information in the first table for the access user based on the permission information comprises:
in response to the access user not having permission information, hiding the data row information in the first table and displaying link information of the second table in a region where the data row information in the first table is located; or
displaying the data row information in the first table in response to the access user having the permission information.

According to one or more embodiments of the present disclosure, provided a table content processing method, further comprising:
obtaining field information of the first table and the second table;
detecting whether the field information of the second table is consistent with that of the first table; and
hiding the field information in the second table in response to the field information of the second table being inconsistent with that of the first table, wherein
the field information comprises at least column headings and/or column attributes.

According to one or more embodiments of the present disclosure, provided a table content processing method, further comprising:
displaying the inconsistent field information as empty in the first table and the second table.

According to one or more embodiments of the present disclosure, provided a table content processing method, in response to adding field information to one of the first table and the second table and the field information added exists in another of the first table and the second table, inserting the field information into the one table and filling in corresponding initialized content.

According to one or more embodiments of the present disclosure, provided a table content processing apparatus, comprising:
an information selection module, configured to select data row information in a first table;
a document generation module, configured to generate a first document or second table in response to a trigger operation on the data row information, wherein the first document comprises the second table, and the second table comprises the data row information;
a document sending module, configured to send the first document or second table to a target access user; and
a reference synchronization module, configured to reference data row information in the second table in a region of the data row information in the first table, and in response to an edit operation on the data row information in the second table, display edited data row information in the data row information of the first table.

According to one or more embodiments of the present disclosure, provided a table content processing apparatus, further comprising:
a display module, configured to highlight an associated region of the data row information in the first table, and display a name and/or link of the second table in response to a trigger operation on the associated region;
a sharing setting module, configured to set a name of the first document or a name of the second table, or set a sending object; and
a permission control module, configured to determine permission information of an access user for the first document or second table, and determine display content of the data row information in the first table for the access user based on the permission information, wherein
the permission control module is further configured to in response to the access user not having permission information, hide the data row information in the first table and display link information of the second table in a region where the data row information in the first table is located; or in response to the access user having the permission information, display the data row information in the first table.

According to one or more embodiments of the present disclosure, provided a table content processing apparatus, further comprising:
a field information obtaining module, configured to obtain field information of the first table and the second table;
a field information detection module, configured to detect whether the field information of the second table is consistent with that of the first table;
a field information display module, configured to hide the field information in the second table in response to the field information of the second table being inconsistent with that of the first table, and
display the inconsistent field information as empty in the first table and the second table; and
a field information addition module, configured to, in response to adding field information to one of the first table and the second table and the field information added exists in another of the first table and the second table, inserting the field information into the one table and filling in corresponding initialized content, wherein
the field information comprises at least column headings and/or column attributes.

According to one or more embodiments of the present disclosure, provided a table content processing method, comprising:
selecting first data row information in a first table; and
inserting the first data row information into a first document or second table in response to an insertion operation in the first document or second table, to generate second data row information, wherein the first data row information and the second data row information have a reference relationship.

According to one or more embodiments of the present disclosure, provided a table content processing method,
the first document comprises the second table.

According to one or more embodiments of the present disclosure, provided a table content processing method, the method further comprises:
in response to an edit operation on the first data row information, displaying edited first data row information in the second data row information.

According to one or more embodiments of the present disclosure, provided a table content processing method, further comprising:
determining whether a preset attribute of the first table and a preset attribute of the second table are the same in response to the insertion operation in the first document or second table; and
in response to the preset attribute of the first table being the same as the preset attribute of the second table, generating the second data row information and determining whether to establish the reference relationship between the second data row information and the first data row information; or
in response to the preset attribute of the first table not being the same as the preset attribute of the second table, copying the first data row information to the first document or second table to generate the second data row information, or rejecting the insertion operation.

According to one or more embodiments of the present disclosure, provided a table content processing method, further comprising:
generating a reference trigger region in response to the insertion operation in the first document or second table; and
the generating second data row information comprising:
in response to a first trigger operation on the reference trigger region, generating the second data row information and establishing the reference relationship between the second data row information and the first data row information; or
in response to a second trigger operation on the reference trigger region, copying the first data row information to the first document or second table to generate the second data row information.

According to one or more embodiments of the present disclosure, provided a table content processing method, further comprising:
displaying a first reference identifier in an associated region of the first data row information in the first table.

According to one or more embodiments of the present disclosure, provided a table content processing method, further comprising:
displaying a second reference identifier in an associated region of the second data row information in the second table.

According to one or more embodiments of the present disclosure, provided a table content processing method, further comprising:
displaying referenced information of the first data row information in response to a trigger operation on the first reference identifier.

According to one or more embodiments of the present disclosure, provided a table content processing method, further comprising:
displaying content update information of the second data row information and/or data source information in response to a trigger operation on the second reference identifier.

According to one or more embodiments of the present disclosure, provided a table content processing method, further comprising:
obtaining field information of the first table and the second table;
detecting whether the field information of the second table is consistent with that of the first table; and
hiding the field information in the second table in response to the field information of the second table being inconsistent with that of the first table, wherein
the field information comprises at least column headings and/or column attributes.

According to one or more embodiments of the present disclosure, provided a table content processing method, further comprising:
displaying the inconsistent field information as empty in the first table and the second table.

According to one or more embodiments of the present disclosure, provided a table content processing method, in response to adding field information to one of the first table and the second table and the field information added exists in another of the first table and the second table, inserting the field information into the one table and filling in corresponding initialized content.

According to one or more embodiments of the present disclosure, provided a table content processing apparatus, comprising:
an information selection module, configured to select first data row information in a first table;
an information insertion module, configured to insert the first data row information into a first document or second table in response to an insertion operation in the first document or second table, to generate second data row information, wherein the first data row information and the second data row information have a reference relationship;
a display module, configured to in response to an edit operation on the first data row information, display edited first data row information in the second data row information, and configured to display the reference relationship with a unique identifier; and
a determination and setting module, configured to determine whether a preset attribute of the first table and a preset attribute of the second table are the same, and in response to the preset attribute of the first table being the same as the preset attribute of the second table, generate the second data row information and determine whether to establish the reference relationship between the second data row information and the first data row information; or in response to the preset attribute of the first table not being the same as the preset attribute of the second table, copy the first data row information to the first document or second table to generate the second data row information, or reject the insertion operation.

According to one or more embodiments of the present disclosure, provided a computer device, comprising a memory and a processor, the memory storing a computer program, and the processor implementing the method according to any one of above when executing the computer program.

According to one or more embodiments of the present disclosure, provided a computer-readable storage medium, wherein the computer-readable storage medium stores a computer program, and the method according to any one of above is implemented when the computer program is performed by a processor.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept. For example, a technical solution formed by interchanging the above-mentioned features with technical features having similar functions disclosed in the present disclosure (but not limited to).

Furthermore, although the operations are depicted using a particular order, this should not be construed as requiring that the operations be performed in the particular order shown or in a sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logic actions, it should be understood that the subject matter defined in the appended claims is not necessarily limited to the particular features or actions described above. Rather, the particular features and actions described above are merely exemplary forms of realizing the claims.

What is claimed is:

1. A table content processing method, comprising:
selecting data row information in a first table;
generating a first document or second table in response to a trigger operation on the data row information, wherein the first document comprises the second table, and the second table comprises the data row information; and
sending the first document or second table to a target access user.

2. The table content processing method according to claim 1, wherein the method further comprises:
referencing data row information in the second table in a region of the data row information in the first table;
or,
the table content processing method further comprises:
in response to an edit operation on the data row information in the second table, displaying edited data row information in the data row information of the first table.

3. The table content processing method according to claim 2, wherein the referencing data row information in the second table in a region of the data row information in the first table comprises:
highlighting an associated region of the data row information in the first table.

4. The table content processing method according to claim 3, wherein the method further comprises:
displaying a name and/or link of the second table in response to a trigger operation on the associated region.

5. The table content processing method according to claim 1, wherein
the trigger operation comprises setting a name of the first document or a name of the second table, or setting a sending object.

6. The table content processing method according to claim 1, further comprising:
determining permission information of an access user for the first document or second table; and
determining display content of the data row information in the first table for the access user based on the permission information.

7. The table content processing method according to claim 6, wherein the determining display content of the data row information in the first table for the access user based on the permission information comprises:
in response to the access user not having permission information, hiding the data row information in the first table and displaying link information of the second table in a region where the data row information in the first table is located; or
displaying the data row information in the first table in response to the access user having the permission information.

8. The table content processing method according to claim 1, further comprising:
obtaining field information of the first table and the second table;
detecting whether the field information of the second table is consistent with that of the first table; and
hiding the field information in the second table in response to the field information of the second table being inconsistent with that of the first table, and displaying the inconsistent field information as empty in the first table and the second table;
wherein the field information comprises at least column headings and/or column attributes.

9. The table content processing method according to claim 8, wherein
in response to adding field information to one of the first table and the second table and the field information added exists in another of the first table and the second table, inserting the field information into the one table and filling in corresponding initialized content.

10. A table content processing method, comprising:
selecting first data row information in a first table; and
inserting the first data row information into a first document or second table in response to an insertion operation in the first document or second table, to generate second data row information, wherein the first data row information and the second data row information have a reference relationship.

11. The table content processing method according to claim 10, wherein the method further comprises:
in response to an edit operation on the first data row information, displaying edited first data row information in the second data row information.

12. The table content processing method according to claim 10, further comprising:
determining whether a preset attribute of the first table and a preset attribute of the second table are the same in response to the insertion operation in the first document or second table; and
in response to the preset attribute of the first table being the same as the preset attribute of the second table, generating the second data row information and determining whether to establish the reference relationship between the second data row information and the first data row information; or
in response to the preset attribute of the first table not being the same as the preset attribute of the second table, copying the first data row information to the first document or second table to generate the second data row information, or rejecting the insertion operation.

13. The table content processing method according to claim 10, further comprising:
generating a reference trigger region in response to the insertion operation in the first document or second table; and
the generating second data row information comprising:
in response to a first trigger operation on the reference trigger region, generating the second data row information and establishing the reference relationship between the second data row information and the first data row information; or
in response to a second trigger operation on the reference trigger region, copying the first data row information to the first document or second table to generate the second data row information.

14. The table content processing method according to claim 10, further comprising:
displaying a first reference identifier in an associated region of the first data row information in the first table;
or,
the table content processing method further comprising:
displaying a second reference identifier in an associated region of the second data row information in the second table.

15. The table content processing method according to claim 14, further comprising:
displaying referenced information of the first data row information in response to a trigger operation on the first reference identifier;
or,
the table content processing method further comprising:
displaying content update information of the second data row information and/or data source information in response to a trigger operation on the second reference identifier.

16. The table content processing method according to claim 10, further comprising:
obtaining field information of the first table and the second table;
detecting whether the field information of the second table is consistent with that of the first table; and
hiding the field information in the second table in response to the field information is inconsistent with that of the first table, wherein
the field information comprises at least column headings and/or column attributes.

17. The table content processing method according to claim 16, further comprising:
displaying the inconsistent field information as empty in the first table and the second table.

18. The table content processing method according to claim 16, wherein
in response to adding field information to one of the first table and the second table and the field information added exists in another of the first table and the second table, inserting the field information into the one table and filling in corresponding initialized content.

19. A computer device, comprising a memory and a processor, the memory storing a computer program, and the processor implementing a table content processing method when executing the computer program, the table content processing method comprises:
selecting data row information in a first table;
generating a first document or second table in response to a trigger operation on the data row information, wherein the first document comprises the second table, and the second table comprises the data row information; and
sending the first document or second table to a target access user.

20. A computer device, comprising a memory and a processor, the memory storing a computer program, and the processor implementing a table content processing method when executing the computer program, the table content processing method comprises: selecting first data row information in a first table; and
inserting the first data row information into a first document or second table in response to an insertion operation in the first document or second table, to generate second data row information, wherein the first data row information and the second data row information have a reference relationship.
